(19) United States
(12) Patent Application Publication
(10) Pub. No.: US 2008/0319704 A1
(43) Pub. Date: Dec. 25, 2008

(54) Device and Method for Determining Spatial Co-Ordinates of an Object

(75) Inventor: Frank Forster, Munchen (DE)

Correspondence Address: YOUNG & THOMPSON, 209 Madison Street, Suite 500, ALEXANDRIA, VA, 22314, US

(73) Assignee: SIEMENS AKTIENGESELLSCHAFT, MUNCHEN (DE)

(21) Appl. No.: 10/588,495

(22) PCT Filed: Feb. 16, 2005
(86) PCT No.: PCT/EP2005/050669

§ 371 Date: Aug. 4, 2006

(30) Foreign Application Priority Data
Feb. 24, 2004 (DE) 10 2004 008 904.3

(51) Int. Cl. G06F 15/00

(52) U.S. Cl. 702/150

(57) ABSTRACT

The invention relates to a measuring device (1) which is used to determine three-dimensional object data. Said measuring device comprises at least two cameras (6) in addition to a projector (3), said cameras capturing object images which are different from the object (2). Said object images can be processed in a data processing unit (7) according to the structured light attachment and according to the stereo viewing principle. As a result, reliability of the obtained data is significantly increased.

The invention relates to a device for determining spatial co-ordinates of an object with:
a projector which projects onto the object a pattern with known projection data;
a camera which creates an object image of the pattern projected onto the object;
a data processing unit connected downstream from the camera, which creates spatial co-ordinates of the object from the object image and the known projection data.

The invention further relates to a method for determination of spatial co-ordinates of an object with the following steps:
Projection of a pattern with known projection data onto an object,
Creation of an object image with the aid of a camera, and
Determination of the spatial co-ordinates from the known projection data in a data processing unit.

A device and a method of this type are known from DE 199 63 333 A1. With the known device and the known method a two-dimensional color pattern is projected by a projector onto the surface of the object to be investigated. A camera, the position of which is known relative to the projector, records the color pattern projected onto the object. Subsequently the three-dimensional coordinates of a point on the surface of the object can be calculated with the aid of a triangulation process.

The known device and the known method are especially suitable for calibrating, large-surface single-color objects. If however the surface of the object to be calibrated is structured in small parts in a spatial respect or in relation to the coloring of the object, it is frequently difficult to analyze the object image, since either the projected pattern, because of shadowing or edges, is only contained incompletely in the object image, or because the projected color pattern is falsified by the coloration of the surface of the object to be measured. In addition the local resolution of the known method is restricted since color surfaces with a specific spatial extent must be used for encoding the project data in the color pattern.

Using this prior art as its starting point, the object of the invention is to create a method and a device with which surfaces structured in small parts of an object to be calibrated can also be recorded with greater accuracy.

This object is achieved by a device and a method with the features of the independent claims. Advantageous embodiments and developments are specified in dependent claims.

The outstanding feature of the device is that at least one further camera creates a further object image and the data processing unit determines additional spatial co-ordinates of the object from the object images using a triangulation process.

With the device the spatial co-ordinates can be determined in two ways. On the one hand it is possible to evaluate the pattern images independently of each other on the basis of the known projection data of the projected pattern. Preferably in this case the spatial co-ordinates are determined from the pattern images on the basis of the projection data of the projected pattern. Only if a pixel in one of the two pattern images cannot be assigned any spatial co-ordinates are pixels which correspond to each other looked for in both pattern images and an attempt is made, with the aid of a triangulation process, to determine the missing spatial co-ordinates.

In a preferred embodiment of the device and of the method, the pixels which correspond to each other are searched for along what are known as epipolar lines. The epipolar lines are the projection of the line of sight assigned to a pixel of a pattern image into another pattern image. The pattern projected onto the object to be measured is in this case preferably embodied so that the epipolar lines pass through a plurality of pattern surfaces, so that in the search along the epipolar lines there can be reference back to the location information encoded in the projected pattern.

In a further preferred embodiment the pattern projected onto the object contains redundantly encoded location information. This enables errors in the decoding of the pattern to be eliminated.

Further characteristics and advantages of the invention emerge from the description below, in which exemplary embodiments of the invention are explained with reference to the enclosed drawing. The figures show:

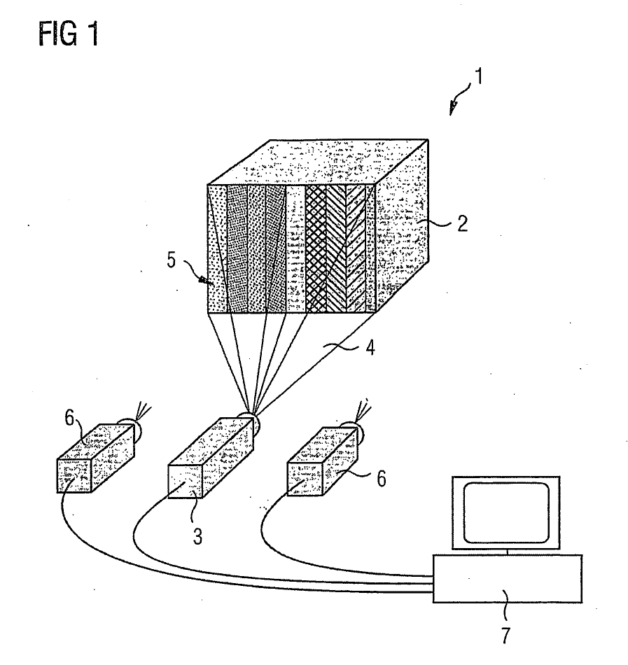

FIG. 1 a device for determining the spatial structure of an object; and

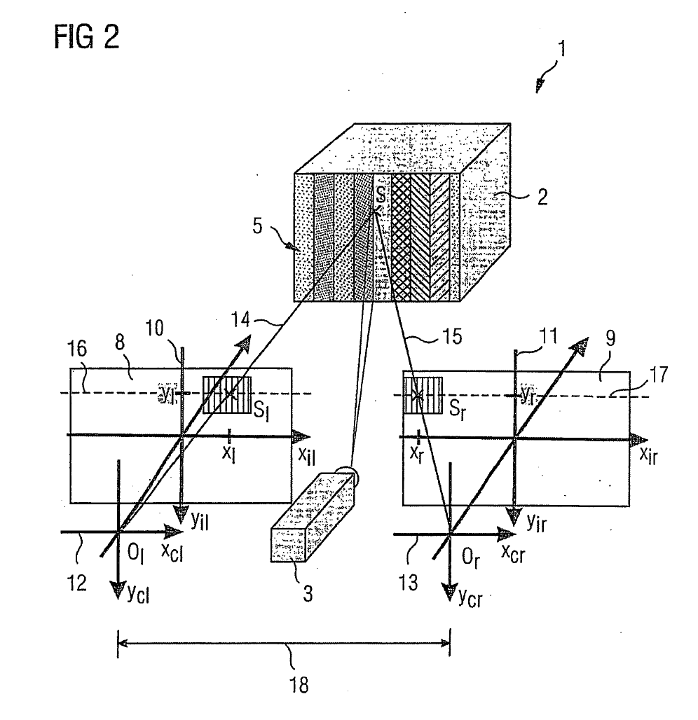

FIG. 2 a depiction of the device from FIG. 1 with lines of sight and image co-ordinate systems indicated.

FIG. 1 shows a measuring device 1 for determining the spatial structure of an object 2. The measurement device 1 comprises a projector 3, which projects a pattern 4 onto a surface 5 of the object 2. Cameras 6 which record the pattern 4 projected on the object 2 are arranged alongside the projector 3. The cameras 6 are each connected to a computer 7.

The cameras 6 create the pattern images 8 and 9 shown in FIG. 2. The positions of the pixels Sₗ and Sᵣ in the pattern images 8 and 9 are described with the aid of image co-ordinate systems 10 and 11. Furthermore lens co-ordinate systems 12 and 13 are shown in FIG. 2, which explain the position of lenses of the cameras 6. In practice the pattern images 8 and 9 are located in the beam direction behind the lenses of the cameras 6 and 7. For the sake of simplicity however the pattern images 8 and 9 are shown in FIG. 2 in the beam direction in front of the lens co-ordinate systems 12 and 13. However this does not change the geometrical circumstances in any way.

Furthermore two lines of sight 14 and 15 are indicated in FIG. 2 which each run from an object point S on the surface 5 of the object 2 to an origin Oₗ of the lens co-ordinate system 12 and to an origin Oᵣ of the lens co-ordinate system 13. Along the lines of sight 14 and 15 the object point S is mapped in the pattern image 8 onto the pixel Sₗ and in the pattern image 9 onto the pixel Sᵣ. The pixels Sₗ and Sᵣ are also referred to as corresponding pixels. The pixels Sₗ and Sᵣ corresponding to each other lie on the epipolar lines 16 and 17, which are the projection of the lines of sight 14 and 15 into the other pattern image 8 and 9 in each case.

The surface co-ordinates of the surface 5 of the object 2 can be determined in the measurement device 1 on the one hand using the structured light approach. With this method for example, as shown in FIGS. 1 and 2, the object to be calibrated is illuminated with a pattern of stripes. For each pixel in the pattern images 8 and 9 the plane is now to be identified in which the object point S lies, which corresponds to the pixel Sₗ or pixel Sᵣ. This task is also referred to as the identification problem. Since the angles are known at which a strip of the pattern 4 is projected onto the object 2, the angle of the line of sight 14 or 15 can be determined after identification of the relevant plane or of the relevant strip in the pattern image 8 or 9. Since furthermore the distance between the projector 3 and relevant camera 6 is known, triangulation can be used to determine the distance of the object point S from one of the pattern images 8 or 9.

With the coded light approach, a modified embodiment of the structure light approach, the identification problem is resolved by different patterns 4 composed of strips being projected consecutively onto the object 2, with the strip widths of the pattern 4 varying. For each of these projections a pattern image 8 or 9 is recorded and for each pixel in the pattern image 8 or 9 the relevant color is established. With black and white images the determination of the color is restricted to establishing whether the relevant object point appears light or dark. For each pixel the determination of the color recorded for a specific projection now produces a multidigit code by which the plane in which the associated object point S lies can be identified.

Especially high resolutions can be achieved with this embodiment of the coded light approach. Because however with this method each object point S must retain its position during the projection, the method is only suited to static immobile objects, but not to moving of objects which change their shape, such as persons or objects moving on a transport device for example.

In a modified embodiment of the coded light approach the relevant planes are encoded spatially in one- or two-dimensional patterns in that the project data or local information is encoded through groups of adjacent different-colored stripes or rectangles or through different symbols. The groups of adjacent different-colored stripes or rectangles which contain location information are referred to below as marks. Such a mark consists of the horizontal sequence of four adjacent colored strips in each case, with the individual marks also being able to overlap. The spatial marks contained in the pattern images 8 and 9 are decoded in the computer 7 and the location information is thereby retrieved. If the marks are completely visible in the pattern images 8 and 9, this method enables the coordinates of the surface 5 of the object to basically be obtained even if the object 2 moves. Reliability in decoding the marks can be improved even further by redundant codes being used for encoding the marks, which allows the detection of errors.

Such codes can be decoded with commercially-available workstation computers 7 in real time, since for each pixel of the pattern image 8 or 9 only a restricted environment has to be analyzed.

If the surface to be measured 5 features spatial structures which are smaller than the projected marks however, this can result in difficulties in the decoding, since under some circumstances marks are not completely visible. In addition the reflection on the surface 5 can also be disturbed. For example the surface 5 itself can exhibit a pattern of stripes which greatly disturbs the pattern 4 projected onto the surface 5. Such a pattern greatly disturbing the projected pattern 4 is for example the stripe pattern of a bar code. Furthermore inaccuracies in the determination of the spatial co-ordinates frequently occur at the edges of the object 2, since the marks along the edges of the object break off abruptly.

With the measuring device 1 a plurality of cameras 6 is provided for resolving these problems. If necessary more than two cameras 6 can also be used for a measuring device of the type of measuring device 1.

In a first step the pattern images 8 and 9 recorded by the cameras 6 are evaluated in accordance with the structured light approach. This then produces n depth maps. In general however areas occur in these depth maps in which, for the reasons given above, no depth value could be determined. In most cases the proportion of the problem areas in which no depth values can be determined is relatively small in relation to the overall area.

In a second step a stereo processing in accordance with the principle of stereo viewing is now undertaken.

The co-ordinates of the surface 5 of the object 2 can be obtained in accordance with the principle of stereo viewing by the surface 5 being recorded by the cameras 6, in which case the positions of the cameras 6 are known precisely. If, as shown in FIG. 2, the pixels Sₗ and Sᵣ assigned to an object point S can be identified in the pattern images 8 and 9, the spatial position of the object point S follows from the intersection of the at least two lines of sight 14 and 15. Two positions of the cameras 6 and of the object point S in each case form a triangle with a base 18 of known length and known base angles φ₁ and φᵣ. This enables the co-ordinates of the object point S on the surface 5 to be determined with the aid of what is known as triangulation.

However the finding of corresponding image points Sₗ and Sᵣ is susceptible to problems. The solution of the correspondence problem is initially actually simplified by the fact that an object point S with pixel Sₗ must lie on the line of sight 14 defined by Sₗ and the known camera geometry. The search for the image points Sᵣ in the pattern image 9 can also be restricted to the projection of the line of sight 14 in the image plane of the other camera 6, to the so-called epipolar line 17. However the solution of the correspondence problem remains difficult, especially under real time conditions.

Basically there is the option of making certain assumptions about the pattern image 8 or 9. For example the assumption can be made that the pattern images 8 and 9 appear approximately the same (similarity constrain”), or it can be assumed that the spatial order of the features of the object 2 is the same in all pattern images 8 and 9 (ordering constraint). These assumptions do not however apply under all circumstances since the appearance of the object 2 depends greatly on the angle of observation.

With a measuring device 1 the solution to the correspondence problem is simplified however by projecting the known pattern 4 onto the object 2. With the measuring device 1 the search thus only needs to be undertaken along the epipolar lines 16 and 17 for corresponding mark sections. With single-color surfaces in particular this is a major advantage.

In addition the stereo processing step is performed exclusively in the problem areas in which the structured light approach could not deliver any spatial co-ordinates of the object 2. Frequently the problem areas involved are areas with a marked optical structure which is further strengthened by the projection of the pattern 4. The problem areas are thus generally well suited for processing according to the principle of stereo viewing.

Furthermore the stereo processing step can be used to increase the local resolution since correspondence points can also be determined within the marks. Thus it is possible with the combined method to assign an exact depth value not only to the mark boundaries or other mark features, but to each pixel of the cameras 6.

Finally shadows can be avoided by using the measuring device 1, since the depth values can be calculated when an area of the surface 5 lies in the shared field of vision of at least two cameras 6 or of a camera 6 and the projector 3.

Thus it is possible with the measuring device 1, by contrast with conventional measuring devices, even with very small or very bright objects with many changes of depth under uncontrolled recording conditions, for example with strong outside light, to obtain precise three-dimensional data of very high resolution with a single pair of pattern images 8 and 9. In particular three-dimensional data of moving objects 2 can be determined, such as a person going past or objects on a conveyor belt for example. The data supplied by the cameras 6 can be evaluated in real time on a commercially available workstation computer.

By comparison with a device operating solely on the principle of stereo viewing, the measuring device 1 is far more efficient, and as a result of the redundant encoding of the pattern 4, significantly more reliable. In addition the measuring device 1 also delivers reliable data for optically unstructured surfaces and contributes to reducing shadowing.

By comparison with devices operating entirely according to the structured light approach, the measuring device 1 delivers more precise data for object edges and small surfaces 5. Furthermore precise data is also generated even if the reflection of the marks is disturbed. Finally a higher spatial resolution can be obtained. Shadowing is also suppressed better compared to the prior art.

The measuring device 1 described here is suitable for the robust recording of finely structured surfaces in real time even with rapidly moving colored objects 2 in uncontrolled environments such as in the open air, in public building or in production shops. The need arises in association with construction for three-dimensional measurement of objects for replicas, for the manufacture of spare parts or the expansion of existing systems or machines. These requirements can be fulfilled with the aid of measuring device 1. Measuring device 1 can also be used in quality assurance. Measuring device 1 is further suitable for identifying and authentication of persons with reference to biometric features, for example for facial recognition or three-dimensional verification by hand geometry checking. Measuring device 1 can furthermore also be used for tasks such as quality control of foodstuffs or three-dimensional recording of objects for the modeling of objects for virtual realities in the multimedia and games area.

1. Device for determining spatial co-ordinates of an object (2) with:
a projector (3) which projects onto the object (2) a pattern (4) with known projection data,
a camera (6) which creates an object image (8) of the pattern (4) projected onto the object (2), and with
a data processing unit (7) connected downstream from the camera (6), which determines spatial co-ordinates of the object (2) from the object image (8) and the known projection data,
characterized in that,
at least one further camera (6) creates a further object image (9) and the data processing unit (7) determines additional spatial co-ordinates of the object (2) from the object images (8, 9) by means of a triangulation method and the pattern (4) contains redundant encoded projection data.

2. Device as claimed in claim 1,
characterized in that,
the pattern (4) contains redundantly-encoded projection data.

3. Device as claimed in claim 1,
characterized in that,
Epipolar lines (16, 17) pass through a plurality of marks of the pattern (4).

4. Device as claimed in claim 1,
characterized in that,
the data processing unit (7) restricts the search for Corresponding image points (Sₗ, Sᵣ) to problem areas in which an evaluation of the pattern images (8, 9) only produces an erroneous result.

5. Method for determining spatial co-ordinates of an object (2) with the following steps:
Projection of a pattern (4) with known projection data onto an object (2);
Creation of an object image (8) with the aid of a camera (6); and
Determination of the spatial co-ordinates from the known projection data in a data processing unit (7),
characterized in that,
with the aid of a further camera (6) a further object image (9) is recorded and that, if the spatial co-ordinates are determined incorrectly, additional spatial co-ordinates of the object (2) are determined on the basis of the projection data and one of the pattern images (8, 9) by searching for corresponding image points (Sₗ, Sᵣ) in the object images (8, 9) and a subsequent triangulation.

6. Method as claimed in claim 5,
characterized in that,
corresponding pixels (Sₗ, Sᵣ) are searched for along the epipolar lines (16, 17).

7. Device as claimed in claim 2,
characterized in that,
Epipolar lines (16, 17) pass through a plurality of marks of the pattern (4).

8. Device as claimed in claim 2,
characterized in that,
the data processing unit (7) restricts the search for corresponding image points (Sₗ, Sᵣ) to problem areas in which an evaluation of the pattern images (8, 9) only produces an erroneous result.

9. Device as claimed in claim 3,
characterized in that,
the data processing unit (7) restricts the search for corresponding image points (Sₗ, Sᵣ) to problem areas in which an evaluation of the pattern images (8, 9) only produces an erroneous result.
